(19) United States
(12) Patent Application Publication
(10) Pub. No.: US 2025/0173634 A1
(43) Pub. Date: May 29, 2025

(54) DELIVERY PLAN CREATION SYSTEM, METHOD, AND PROGRAM

(71) Applicant: NEC Corporation, Minato-ku, Tokyo (JP)

(72) Inventors: Nobutatsu Nakamura, Tokyo (JP); Monta Yashi, Tokyo (JP)

(73) Assignee: NEC Corporation, Minato-ku, Tokyo (JP)

(21) Appl. No.: 18/842,074

(22) PCT Filed: Mar. 28, 2022
(86) PCT No.: PCT/JP2022/015126

§ 371 Date: Aug. 28, 2024

(51) Int. Cl. G06Q 10/04; G06Q 10/083

(52) U.S. Cl. CPC G06Q 10/04; G06Q 10/083

(57) ABSTRACT

The delivery request accepting means 191 accepts input of an additional delivery request including a specification of multiple delivery conditions. The delivery request extracting means 192 extracts a delivery request corresponding to the input delivery conditions including the additional delivery request. The optimizing means 193 optimizes a delivery plan for the extracted delivery request for each delivery condition. The output means 194 outputs the optimized delivery plan for each delivery condition.

### TECHNICAL FIELD

The present invention relates to a delivery plan creation system, a delivery plan creation method, and a delivery plan creation program for creating delivery plans.

### BACKGROUND ART

Delivery requests constantly change. Therefore, various methods for creating delivery plans that respond to changes in circumstances have been proposed.

Patent Literature 1 describes a delivery schedule selection system aimed at user convenience and efficient delivery. The system described in Patent Literature 1 calculates delivery costs for each of several selectable delivery schedule candidates for delivering products ordered by users, taking into account future delivery schedules of other packages and expected increases/decreases in delivery schedules.

Patent Literature 2 describes a transport management system for efficient transportation. In the system described in Patent Literature 2, regular transport services (scheduled services) that operate at predetermined times and transport services (temporary services) that operate based on applications are managed, and costs for transport services when changed according to additional transport requests are calculated based on time-based fare calculation results calculated from the time taken to operate the scheduled and temporary services.

Patent Literature 3 describes an example of an objective function used for optimizing delivery plans.

### CITATION LIST

### Patent Literature

PL 1: International Publication No. WO2015/111224
PL 2: Japanese Patent Application Laid-Open No. 2013-129510
PL 3: Japanese Patent Application Laid-Open No. 2021-165196

### SUMMARY OF INVENTION

### Technical Problem

The method described in Patent Literature 1 calculates delivery costs for multiple candidates by taking into account future delivery schedules of other packages and expected increases/decreases in delivery schedules when receiving an order from a user. However, since the system described in Patent Literature 1 is a system that directly accepts orders from users, it is not intended to change the future delivery schedules requested by other users.

In other words, the method described in Patent Literature 1 simply calculates delivery costs when additional orders are added to existing or predicted delivery schedules. Therefore, the calculated delivery costs are not determined considering the overall delivery plan, making it difficult to say that a more appropriate delivery schedule is being created.

In addition, the system described in Patent Literature 2 calculates cost for transport service by subtracting the cost of the transport service that was planned before the additional transport was carried from the cost of the transport service when it is changed in response to the additional transport request, regardless of the content of the additional request. Therefore, like the system described in Patent Literature 1, the system described in Patent Literature 2 does not take into account the overall delivery plan in its calculations, and it is difficult to say that a more appropriate delivery schedule is being created.

Therefore, the purpose of the present invention is to provide a delivery plan creation system, a delivery plan creation method, and a delivery plan creation program capable of creating delivery plans considering situations that may be changed by additional delivery requests from multiple perspectives.

### Solution to Problem

The delivery plan creation system according to the present invention includes a delivery request accepting means for accepting input of an additional delivery request including a specification of multiple delivery conditions, a delivery request extracting means for extracting a delivery request corresponding to the input delivery conditions, including the additional delivery request, an optimizing means for optimizing a delivery plan for the extracted delivery request for each delivery condition, and an output means for outputting the optimized delivery plan for each delivery condition.

The delivery plan creation method by a computer includes: accepting input of an additional delivery request including a specification of multiple delivery conditions; extracting a delivery request corresponding to the input delivery conditions, including the additional delivery request; optimizing a delivery plan for the extracted delivery request for each delivery condition; and outputting the optimized delivery plan for each delivery condition.

The delivery plan creation program for causing a computer to execute: a delivery request accepting process for accepting input of an additional delivery request including a specification of multiple delivery conditions; a delivery request extracting process for extracting a delivery request corresponding to the input delivery conditions, including the additional delivery request; an optimizing process for optimizing a delivery plan for the extracted delivery request for each delivery condition; and an output process for outputting the optimized delivery plan for each delivery condition.

### Advantageous Effects of Invention

According to the present invention, it is possible to create delivery plans from multiple perspectives considering situations that may be changed by additional delivery requests.

### BRIEF DESCRIPTION OF DRAWINGS

FIG. 1 It depicts a block diagram showing a configuration example of an example embodiment of the delivery plan creation system.

FIG. 2 It depicts an explanatory diagram showing an example of information related to delivery services.

FIG. 3 It depicts a block diagram showing a configuration example of another example embodiment of the delivery plan creation system.

FIG. 4 It depicts an explanatory diagram showing an example of a delivery plan expressed in a Gantt chart.

FIG. 5 It depicts an explanatory diagram showing an example of a process for calculating costs for additional delivery requests.

FIG. 6 It depicts an explanatory diagram showing an operation example of the delivery plan creation system.

FIG. 7 It depicts a flowchart showing an operation example of the delivery plan creation system when delivery time is specified as a delivery condition.

FIG. 8 It depicts a flowchart showing an operation example of the delivery plan creation system when the number of delivery vehicles is specified as a delivery condition.

FIG. 9 It depicts a flowchart showing an operation example of the delivery plan creation system when a delivery base attribute is specified as a delivery condition.

FIG. 10 It depicts a block diagram showing an overview of the delivery plan creation system according to the present invention.

FIG. 11 It depicts a schematic block diagram showing a configuration of a computer according to at least one example embodiment.

### DESCRIPTION OF EMBODIMENTS

Hereinafter, example embodiments of the present invention will be described with reference to the drawings. The delivery plan creation system of the present example embodiment creates optimized delivery plans based on delivery requests specified with multiple delivery conditions that an administrator assumes to be feasible when receiving orders from users.

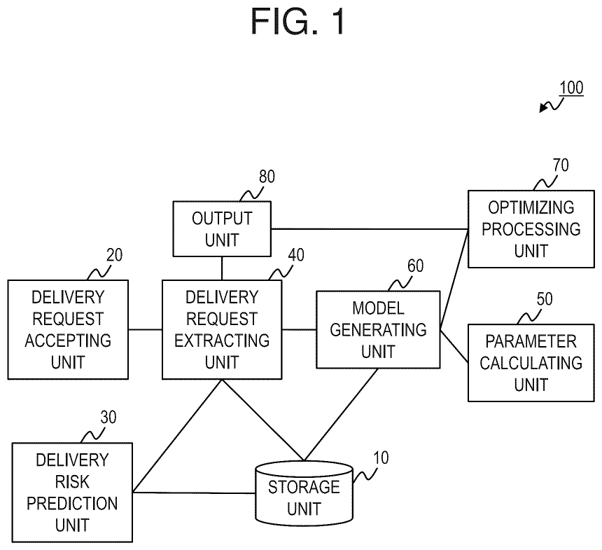

FIG. 1 is a block diagram showing a configuration example of an example embodiment of the delivery plan creation system. The delivery plan creation system 100 of the present example embodiment includes a storage unit 10, a delivery request accepting unit 20, a delivery risk prediction unit 30, a delivery request extracting unit 40, a parameter calculating unit 50, a model generating unit 60, an optimizing processing unit 70, and an output unit 80.

The storage unit 10 stores information used for various processes by the delivery plan creation system 100 of the present example embodiment. Specifically, the storage unit 10 stores delivery plans obtained as a result of optimization processing by the optimizing processing unit 70 described later. The storage unit 10 also stores information related to delivery bases and delivery services (time, place, delivery items, delivery time slots, etc.), as well as predefined parameters. The storage unit 10 is realized, for example, by a magnetic disk or the like.

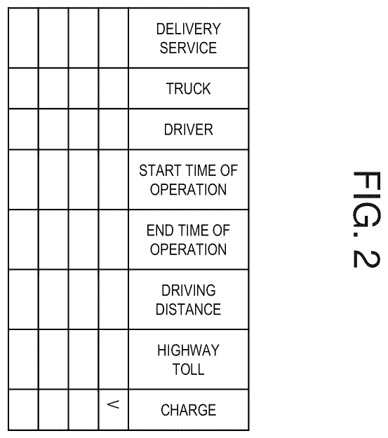

FIG. 2 is an explanatory diagram showing an example of information related to delivery services. The example shown in FIG. 2 indicates that the identification information of trucks and drivers, start and end times of operations, driving distance, highway tolls, and charges when using the delivery service are respectively associated with each delivery service.

The delivery request accepting unit 20 accepts input of a delivery request including specifications of multiple delivery conditions. Hereinafter, to distinguish from already accepted delivery requests, newly accepted delivery requests by the delivery request accepting unit 20 may be referred to as an additional delivery request. The delivery condition includes, for example, delivery time (time at the delivery point), delivery means, and attributes of the delivery base. Examples of delivery means include small trucks, medium trucks, large trucks, trailers, motorcycles, bicycles, airplanes, ships, etc.

For example, when delivery time is specified as a delivery condition, the delivery request accepting unit 20 may accept input of additional delivery requests including specifications of multiple delivery times such as t=+30 minutes, +1 hour, +2 hours, +24 hours, +48 hours to the required time to the delivery destination. If the delivery vehicle is already determined for each delivery time, specifying the delivery time can be considered as specifying the delivery vehicle.

The delivery risk prediction unit 30 predicts delivery requests assumed to be made in the future. Specifically, the delivery risk prediction unit 30 predicts delivery requests corresponding to the input delivery conditions as delivery requests assumed to be made in the future. For example, when delivery time is included as a delivery condition, the delivery risk prediction unit 30 predicts delivery requests assumed to be made at that delivery time in the future.

For example, if the delivery condition is “delivery time=+24 hours,” the delivery risk prediction unit 30 may predict delivery requests up to 24 hours ahead. To suppress the inclusion of delivery services that depart immediately, the delivery risk prediction unit 30 may predict delivery requests up to 24 hours from the time when the predetermined time to is added to the current time.

The method for predicting delivery requests is optional. The delivery risk prediction unit 30 may, for example, predict future delivery requests corresponding to the delivery conditions by calculating the average number of delivery requests that occurred in the same delivery region (direction) during a past time slot based on past delivery request history. Additionally, the delivery risk prediction unit 30 may predict future delivery requests corresponding to the delivery conditions based on recent increases/decreases in delivery volume (previous day, same day of the previous week).

Furthermore, a prediction model may be trained in advance that includes the input delivery conditions and requested environment as explanatory variables and the number of delivery requests that correspond to those delivery conditions as the objective variable. The delivery risk prediction unit 30 may then predict delivery requests using that prediction model.

The delivery request extracting unit 40 extracts delivery requests corresponding to the input delivery conditions, including additional delivery requests. That is, the delivery request extracting unit 40 extracts existing delivery requests corresponding to the input delivery conditions and newly input additional delivery requests together. For example, the delivery request extracting unit 40 may extract delivery requests scheduled for the specified delivery time, including additional delivery requests. This allows all delivery requests corresponding to the input delivery conditions to be extracted.

Furthermore, the delivery request extracting unit 40 may also extract delivery requests expected to be made in the future corresponding to the input delivery conditions. For example, if a delivery request specifying a delivery vehicle is input, the delivery risk prediction unit 30 may predict delivery requests that may be delivered by the same vehicle, and the delivery request extracting unit 40 may extract and list the predicted delivery requests together. This enables generating the final delivery plan early by considering future delivery requests.

If the delivery request extracting unit 40 does not extract predicted future delivery requests, the delivery plan creation system 100 may not include the delivery risk prediction unit 30.

The optimizing processing unit 70 optimizes delivery plans for the delivery requests extracted by the delivery request extracting unit 40 for each delivery condition. That is, the optimizing processing unit 70 derives new delivery plans by performing optimization processing that includes additional delivery requests to the existing delivery requests. For example, the optimizing processing unit 70 may optimize delivery plans for the extracted delivery requests for each specified delivery time.

Specifically, the optimizing processing unit 70 performs a process to find a combination of viewpoints that minimize the value of the model (objective function) generated by the parameter calculating unit 50 and the model generating unit 60 described later, thereby determining the delivery plan that minimizes the resulting costs.

The optimizing processing unit 70 can be realized by any means. For example, the optimizing processing unit 70 may be realized by a general-purpose computer CPU (Central Processing Unit).

Here, since the delivery plan to be optimized in the present example embodiment is a problem of selecting appropriate combinations of items such as packages, delivery vehicles, and delivery times, it can be considered a combinatorial optimization problem. Since it is not practical to search for the optimal combination through exhaustive search or the like, it is common to predefine delivery patterns and optimize by limiting combinations to delivery items and delivery patterns.

On the other hand, when trying to optimize delivery plans for multiple delivery conditions, it is assumed that a lot of computation time is required if a general-purpose computer is used. Therefore, the optimizing processing unit 70 of the present example embodiment may be configured to send the generated objective function to a quantum computer or annealing machine and instruct them to perform optimization processing.

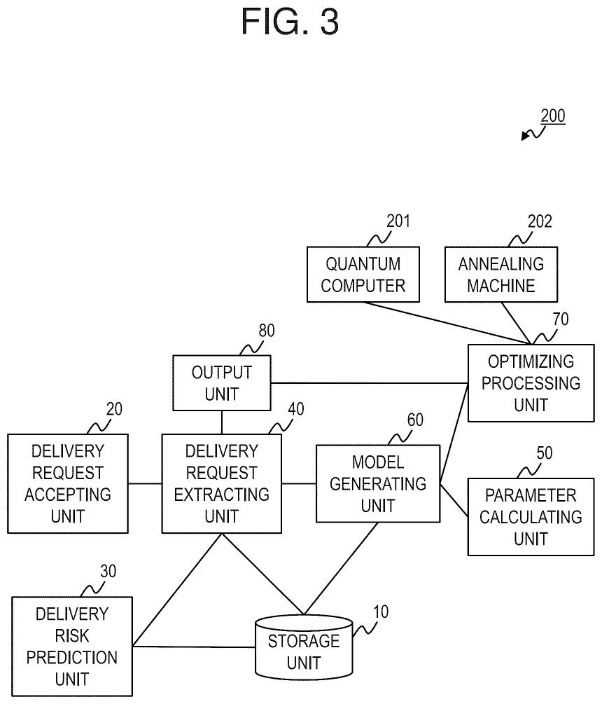

FIG. 3 is a block diagram showing a configuration example of another example embodiment of the delivery plan creation system. As exemplified in FIG. 3, the delivery plan creation system 200 may be connected to a quantum computer 201 and an annealing machine 202. In FIG. 3, the delivery plan creation system 200 is illustrated as being connected to both the quantum computer 201 and the annealing machine 202, but the delivery plan creation system 200 may be connected to either the quantum computer 201 or the annealing machine 202. The other configurations are the same as those illustrated in FIG. 1.

In other words, optimization is performed using the Hamiltonian expression in the case of a quantum computer and the Ising model in the case of an annealing machine. Therefore, the optimizing processing unit 70 may send the model for optimization to the quantum computer or annealing machine to execute the optimization processing. This makes it possible to optimize delivery plans for multiple delivery conditions more efficiently than when using a general-purpose computer.

Various viewpoints can be assumed for optimizing delivery plans. The following specifically describes viewpoints for combinatorial optimization.

The main viewpoint is the cost aspect. For example, in the case of the company's own delivery vehicles, the cost is calculated as the sum of delivery distance×average fuel consumption, driver labor costs, vehicle expenses, etc. In the case of outsourcing to another company, the cost is calculated as the sum of costs from the fare table based on delivery distance and load, vehicle size, and number of days.

Related viewpoints include delivery distance, delivery time, and load rate. The load rate is calculated, for example, by the load (weight)/maximum loading weight of the delivery vehicle or load (volume)/maximum loading volume of the delivery vehicle.

In addition, taking into consideration the load on delivery vehicles, an average load value on delivery vehicles can be used as a viewpoint. The average load value is calculated, for example, as 1/n·Σ(delivery time of each vehicle−average delivery time)² or 1/n·Σ(load rate of each vehicle−average load rate)². This value is preferable when the variance is small.

Another viewpoint other than the cost aspect, considering the impact on the environment, is carbon dioxide emissions. Carbon dioxide emissions are calculated, for example, by (delivery distance×distance coefficient+delivery time×time coefficient)×weight×cumulative elevation difference×vehicle coefficient. Various coefficients are predefined by administrators or others.

The parameter calculating unit 50 calculates parameters used in the model for optimization by the optimizing processing unit 70. The model generating unit 60 generates a model using the parameters generated by the parameter calculating unit 50. The model generated by the model generating unit 60 is specifically an objective function used for optimization processing.

The objective function is a function that defines the optimization target and is represented as a function that adds multiple terms (hereafter denoted as cost terms) combining the above viewpoints and terms added when constraint conditions are not satisfied (hereafter denoted as penalty terms). The objective function may be a function defining the delivery cost required for delivery as the optimization target or a function defining carbon dioxide emissions resulting from delivery as the optimization target. In this case, the optimizing processing unit 70 optimizes the delivery plan by minimizing these objective functions.

However, the optimization target is not limited to cost or carbon dioxide emissions. The optimization target is not limited to one; for example, both the delivery cost and carbon dioxide emissions described above can be optimization targets.

The terms included in the cost terms are represented as terms weighted by various viewpoints. For example, when the viewpoints shown above are used, the objective function is represented by the equation exemplified below.

$$( Equation 1 )$$

$$Objective function = ( cost \times cost weight + load rate \times load rate weight + delivery distance \times deliver distance weight + … ) + penalty terms$$

The parameter calculating unit 50 may calculate the weights as parameters when the various perspectives are selected. In the example of Equation 1 shown above, the parameter calculating unit 50 calculates the weights of cost, load rate, delivery distance, etc. At that time, the parameter calculating unit 50 calculates the weight of the viewpoint to be larger as the viewpoint to be emphasized more.

The content of the objective function is optional and is not limited to the format of Equation 1 shown above. The parameter calculating unit 50 and the model generating unit 60 may generate an objective function in the format described in Patent Document 3 or generate a known objective function. The optimizing processing unit 70 can be realized by any configuration, and the parameter calculating unit 50 may calculate parameters of the model according to the optimization processing to be performed.

For example, when the optimizing processing unit 70 is realized by a quantum computer, and optimization processing is performed by the quantum computer, the parameter calculating unit 50 may calculate parameters used in the Hamiltonian expression used for optimization. Also, for example, when the optimizing processing unit 70 is realized by an annealing machine, and optimization processing is performed by the quantum annealing machine, the parameter calculating unit 50 may calculate parameters used in the Ising model used for optimization. In these cases, the model generating unit 60 may generate the objective function used for optimization using the Hamiltonian expression or Ising model using the generated parameters.

When the optimizing processing unit 70 is realized by a quantum computer or annealing machine, the delivery plan creation system 100 (delivery plan creation system 200) includes additional elements different from the usual elements of a general-purpose computer. Furthermore, the parameter calculating unit 50 and the model generating unit 60 for generating the Hamiltonian expression or Ising model to execute the optimization processing by the quantum computer or annealing machine enhance the functionality of the optimizing processing unit 70 and indicate an improvement in optimization processing.

Below, an example of representing an objective function with a Hamiltonian expression is described. In the Hamiltonian expression, the selection or non-selection of each viewpoint is represented by variable xₙ (Σ{0, 1}). For example, the delivery time is a selected xₙ (i.e. xₙ=1) of the set of variables derived by optimizing the Hamiltonian expression.

For example, it is assumed that a delivery time frame defined every 30 minutes is defined as selectable or not. Here, if delivery is available from 10:00 to 12:00, the specified time range is defined as shown in Table 1, which is illustrated below. In Table 1, 0 indicates that delivery is not possible and 1 indicates that delivery is possible.

TABLE 1
Examples of specified time ranges

| Xₙ | 8:00 | | 9:00 | | 10:00 | | 11:00 | | 12:00 | |
|---|---|---|---|---|---|---|---|---|---|---|
| | 0 | 0 | 0 | 0 | 1 | 1 | 1 | 1 | 0 | 0 |

At this time, the penalty term, which would be a penalty if the variable of the specified time frame is not 1, is represented, for example, by Equation 2 exemplified below. In Equation 2, w is a weighting coefficient indicating the degree of the penalty.

$$Penalty = ( 1 - {x}_{n} ) \times w \qquad ( Equation 2 )$$

Thus, the parameter calculating unit 50 and the model generating unit 60 may calculate parameters according to the assumed viewpoints and generate models using the calculated parameters. Methods for representing objective functions using the Ising model or Hamiltonian expression are widely known, so further explanation is omitted.

The output unit 80 outputs the optimized delivery plans for each delivery condition. The output unit 80 may calculate and output costs (fees) and carbon dioxide emissions for additional delivery requests for each delivery condition. The output unit 80 may, for example, output results optimized for each delivery time.

In this case, the output unit 80 may output each delivery plan itself in a comparable manner or output comparative information comparing results optimized for each delivery condition. A method for outputting delivery plans includes, for example, displaying delivery plans in Gantt charts. As an example of comparative information, differences in costs between delivery plans can be mentioned. Furthermore, the output unit 80 may output delivery conditions and delivery plans in a ranking format according to the resulting costs.

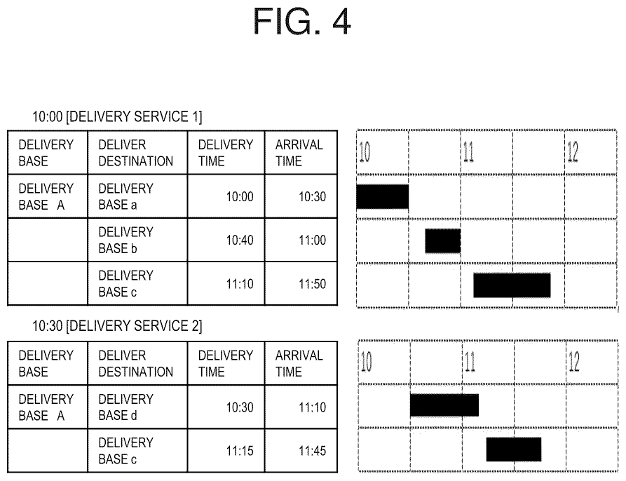

FIG. 4 is an explanatory diagram showing an example of a delivery plan expressed in a Gantt chart. The example shown in FIG. 4 illustrates a case where a delivery plan is generated to deliver a package at 10:00 and another plan to deliver the package at 10:30, allowing comparison of the package's movement.

The output unit 80 may also calculate costs based on a fee formula according to the weight, size and delivery distance of the deliveries according to the total cost of the delivery vehicle, or it may calculate costs based on a fee schedule. Furthermore, since the calculated costs enable the cost to be estimated for delivery requests, the output unit 80 may output (display, notify by email, etc.) the estimated delivery charges corresponding to the estimated costs to the user who placed the order.

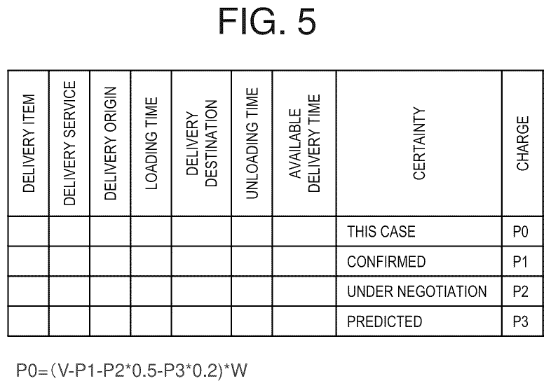

FIG. 5 is an explanatory diagram showing an example of a process for calculating costs for additional delivery requests. The example shown in FIG. 5 corresponds to the information of the delivery origin and destination of the delivery item for which additional delivery requests are made, which delivery service is used, and the loading time, unloading time, and available delivery time slots when using that delivery service. Furthermore, the example shown in FIG. 5 indicates that the certainty (whether it is an additional delivery request (this case), a confirmed delivery request, a delivery request under negotiation, or a predicted delivery request) is associated with each delivery request.

For example, it is assumed that the charge when using a certain delivery service is V. In this case, the output unit 80 may calculate the costs for additional delivery requests based on the value obtained by subtracting the costs for other delivery requests from the charge V for using a certain delivery service. At this time, the output unit 80 may calculate charges for items other than the confirmed delivery request by multiplying them by a predetermined weight value (for example, a weight of 0.5 for delivery requests under negotiation, a weight of 0.2 for predicted delivery requests, etc.). The example shown in FIG. 5 indicates that the charge P₀ for additional delivery requests is calculated by P₀=(V−P₁−P₂×0.5−P₃×0.2) w. Here, w is a predetermined weight value.

The delivery request accepting unit 20, the delivery risk prediction unit 30, the delivery request extracting unit 40, the parameter calculating unit 50, the model generating unit 60, the optimizing processing unit 70, and the output unit 80 are realized, for example, by a computer processor (for example, a CPU) operating according to a program (delivery plan creation program). As mentioned above, the optimizing processing unit 70 may be configured to instruct the execution of optimization processing by a quantum computer or annealing machine.

For example, the program may be stored in the storage unit 10, and the processor may read the program from the storage unit 10, operate as the delivery request accepting unit 20, the delivery risk prediction unit 30, the delivery request extracting unit 40, the parameter calculating unit 50, the model generating unit 60, the optimizing processing unit 70, and the output unit 80 according to the program. Furthermore, the functions of the delivery plan creation system 100 may be provided in the form of Saas (Software as a Service).

The delivery request accepting unit 20, the delivery risk prediction unit 30, the delivery request extracting unit 40, the parameter calculating unit 50, the model generating unit 60, the optimizing processing unit 70, and the output unit 80 may each be realized by dedicated hardware. Moreover, part or all of each component of the device may be realized by a combination of general-purpose or dedicated circuits (circuitry), processors, etc. These may be configured by a single chip or by multiple chips connected via a bus. Part or all of each component of the device may be realized by a combination of the aforementioned circuits and a program.

Furthermore, when some or all components of the delivery plan creation system 100 are realized by multiple information processing devices or circuits, the multiple information processing devices or circuits may be centrally located or distributed. For example, the information processing devices or circuits may be realized in a form connected via a communication network, such as a client-server system or a cloud computing system.

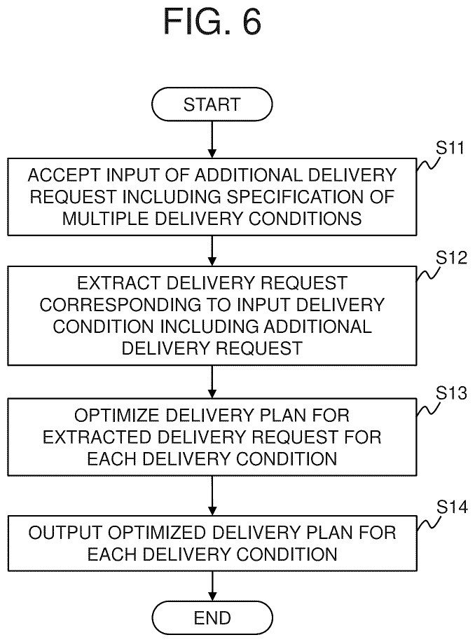

Next, the operation of the delivery plan creation system 100 of the present example embodiment will be described. FIG. 6 is an explanatory diagram showing an operation example of the delivery plan creation system 100 of the present example embodiment. The delivery request accepting unit 20 accepts input of an additional delivery request including a specification of multiple delivery conditions (step S11). The delivery request extracting unit 40 extracts a delivery request corresponding to the input delivery conditions including additional delivery requests (step S12). The optimizing processing unit 70 optimizes a delivery plan for the extracted delivery request for each delivery condition (step S13). The output unit 80 outputs the optimized delivery plan for each delivery condition (step S14).

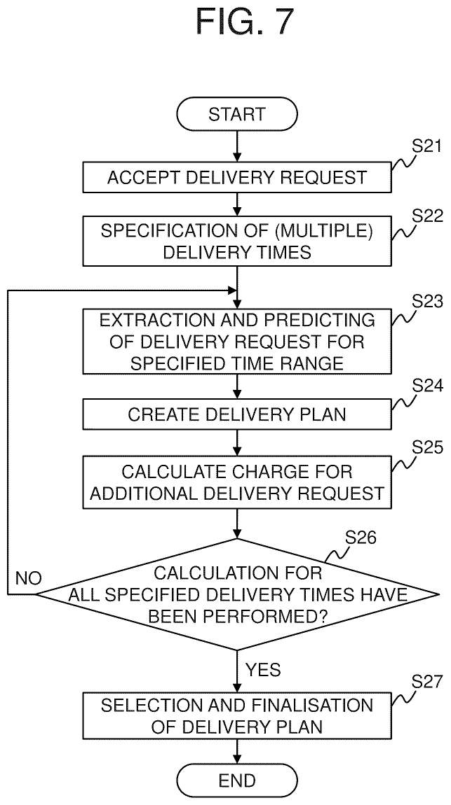

Next, the specific operation of the delivery plan creation system 100 of the present example embodiment will be described with an example of specific delivery conditions. FIG. 7 is a flowchart showing an operation example of the delivery plan creation system 100 when delivery time is specified as a delivery condition.

First, the delivery request accepting unit 20 accepts input of delivery requests (step S21) and further accepts specifications of multiple delivery times (step S22). The delivery risk prediction unit 30 predicts delivery requests for the specified delivery times, and the delivery request extracting unit 40 extracts delivery requests within the specified delivery time range (step S23). The optimizing processing unit 70 creates delivery plans by combinatorial optimization calculation (step S24). Then, the output unit 80 calculates charges for additional delivery requests (step S25).

If the calculations for all specified delivery times have not been performed (No in step S26), the processes from step S23 onwards are repeated for other delivery times. If the calculations for all specified delivery times have been performed (Yes in step S26), the output unit 80 outputs the delivery plans, accepts selections by the administrator, and finalizes the delivery plans (step S27).

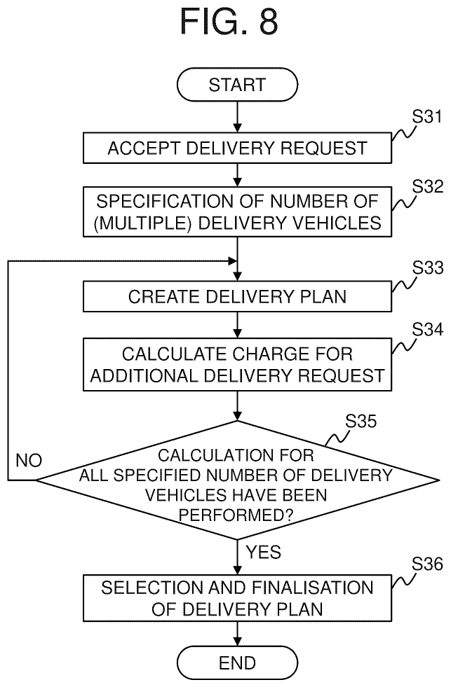

Next, the operation of the delivery plan creation system 100 when the number of delivery vehicles is specified as a delivery condition will be described. FIG. 8 is a flowchart showing an operation example of the delivery plan creation system 100 when the number of delivery vehicles is specified as a delivery condition.

First, the delivery request accepting unit 20 accepts input of delivery requests (step S31) and further accepts specifications of the number of multiple delivery vehicles (step S32). The optimizing processing unit 70 creates delivery plans by combinatorial optimization calculation (step S33). Then, the output unit 80 calculates charges for additional delivery requests (step S34).

If the calculations for all the specified number of delivery vehicles have not been performed (No in step S35), the processes from step S33 onwards are repeated for the other numbers of delivery vehicles. If the calculations for all the specified number of delivery vehicles have been performed (Yes in step S35), the output unit 80 outputs the delivery plans, accepts selections by the administrator, and finalizes the delivery plans (step S36).

By optimizing the delivery plans when changing the number of delivery vehicles, it is possible to derive the optimal types and number of delivery vehicles to be deployed at a delivery base of a delivery company.

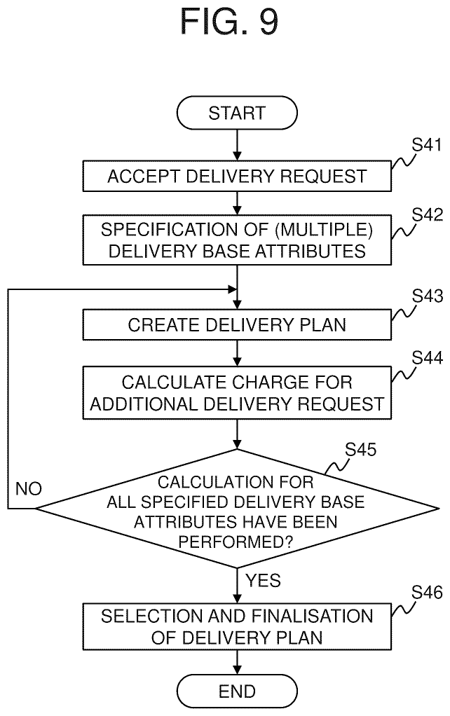

Next, the operation of the delivery plan creation system 100 when a delivery base attribute (collection center, district center location, scale, etc.) is specified as a delivery condition will be described. FIG. 9 is a flowchart showing an operation example of the delivery plan creation system 100 when a delivery base attribute is specified as a delivery condition.

First, the delivery request accepting unit 20 accepts input of delivery requests (step S41) and further accepts specifications of multiple delivery base attributes (step S42). The optimizing processing unit 70 creates delivery plans by combinatorial optimization calculation (step S43). Then, the output unit 80 calculates charges for additional delivery requests (step S44).

If the calculations for all specified delivery base attributes have not been performed (No in step S45), the processes from step S43 onwards are repeated for other delivery base attributes. If the calculations for all specified delivery base attributes have been performed (Yes in step S45), the output unit 80 outputs the delivery plans, accepts selections by the administrator, and finalizes the delivery plans (step S46).

By optimizing the delivery plans when changing delivery base attributes, it is possible to derive where delivery bases should be located for delivery companies.

Next, the operation of the delivery plan creation system 100 of the present example embodiment will be described with a specific example. In the specific example shown below, a quantum computer is used for optimization processing, and a Hamiltonian expression is used as the model (objective function) for optimization. Furthermore, delivery vehicles are specified as delivery conditions.

First, when the data of the delivery item is input, the delivery request accepting unit 20 accepts input of delivery requests related to the delivery item. The delivery request extracting unit 40 lists delivery items (i.e., delivery requests) that may be delivered by the same delivery vehicle as the delivery item, including predictions. The optimizing processing unit 70 uses a quantum computer to calculate the set of variables that minimize the predetermined Hamiltonian expression, including delivery items, delivery vehicles, delivery sequence, and delivery time frames as variables.

The parameter calculating unit 50 calculates the distances (or time, transport costs) between delivery points as coefficients of the variables. The model generating unit 60 generates the Hamiltonian expression considering various conditions. For example, conditions include that the total weight of delivery items does not exceed the loading weight set for each vehicle, the total size or volume of delivery items does not exceed the vehicle's loading space, and the parking space at the delivery site limits the vehicle size and the number of vehicles that can be parked simultaneously.

As a result of the optimization by the optimizing processing unit 70, the output unit 80 outputs delivery plans such as which delivery vehicle to load a certain delivery item, and the delivery sequence of the delivery vehicle for each delivery point from the variable set that minimizes the Hamiltonian expression. Furthermore, by specifying multiple delivery vehicles and varying delivery plans within the possible range, it is possible to compare the total delivery costs within that range.

Generally, if the range is narrow, there are fewer candidate delivery vehicles, and the total delivery cost tends to be higher. Conversely, if the range is wide, the total delivery cost tends to be lower.

For example, depending on the circumstances of the delivery destination, a delivery request that minimizes costs may not necessarily be selected. In the delivery plan creation system 100 of the present example embodiment, since the output unit 80 outputs optimization results for multiple delivery conditions, it is possible to create delivery plans flexibly according to the needs of users and administrators. As a result, it is possible to adjust whether to add or discount the standard delivery charge for additional delivery requests.

As described above, in the present example embodiment, the delivery request accepting unit 20 accepts input of an additional delivery request including a specification of multiple delivery conditions, the delivery request extracting unit 40 extracts a delivery request corresponding to the input delivery conditions including the additional delivery request, the optimizing processing unit 70 optimizes a delivery plan for the extracted delivery request for each delivery condition, and the output unit 80 outputs the optimized delivery plan for each delivery condition. Therefore, it is possible to create delivery plans from multiple perspectives considering situations that may be changed by additional delivery requests.

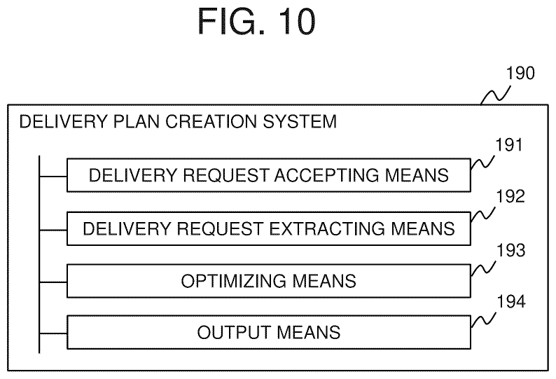

Next, an overview of the present invention will be described. FIG. 10 is a block diagram showing an overview of the delivery plan creation system according to the present invention. The delivery plan creation system 190 (for example, delivery plan creation system 100) according to the present invention includes a delivery request accepting means 191 (for example, delivery request accepting unit 20) for accepting input of an additional delivery request including a specification of multiple delivery conditions (for example, multiple delivery times), a delivery request extracting means 192 (for example, delivery request extracting unit 40) for extracting a delivery request corresponding to the input delivery conditions including the additional delivery request, an optimizing means 193 (for example, optimizing processing unit 70) for optimizing a delivery plan for the extracted delivery request for each delivery condition, and an output means 194 (for example, output unit 80) for outputting the optimized delivery plan for each delivery condition.

With such a configuration, it is possible to create delivery plans from multiple perspectives considering situations that may be changed by additional delivery requests.

Furthermore, the delivery plan creation system 190 may include a delivery risk prediction means (for example, delivery risk prediction unit 30) for predicting a delivery request expected to be made in the future corresponding to the input delivery conditions. The delivery request extracting means 192 may also extract the predicted delivery requests together.

Additionally, the delivery plan creation system 190 may include a model generating unit (for example, model generating unit 60, parameter calculating unit 50) for generating an objective function used for optimization by a Hamiltonian expression or Ising model. The optimizing means 193 may send the generated objective function to a quantum computer or annealing machine to execute optimization processing.

The output means 194 may output comparative information comparing results optimized for each delivery condition.

Specifically, the optimizing means 193 may optimize the delivery plan by minimizing an objective function defining the cost required for delivery.

Alternatively, the optimizing means 193 may optimize the delivery plan by minimizing an objective function defining the carbon dioxide emissions resulting from delivery.

The delivery request accepting means 191 may accept input of the additional delivery request including a specification of multiple delivery times as delivery conditions, the delivery request extracting means 192 may extract the delivery request scheduled for the specified delivery times including the additional delivery requests, the optimizing means 193 may optimize the delivery plan for the extracted delivery request for each specified delivery time, and the output means 194 may output results optimized for each delivery time.

The delivery request accepting means 191 may accept input of the additional delivery request including a specification of multiple delivery vehicles as the delivery conditions, the optimizing means 193 may optimize the delivery plan for the extracted delivery request for each specified number of delivery vehicles, and the output means 194 may output results optimized for each number of delivery vehicles.

The delivery request accepting means 191 may accept input of the additional delivery request including a specification of multiple delivery base attributes as delivery conditions, the optimizing means 193 may optimize the delivery plan for the extracted delivery request for each specified delivery base attribute, and the output means 194 may output results optimized for each delivery base attribute.

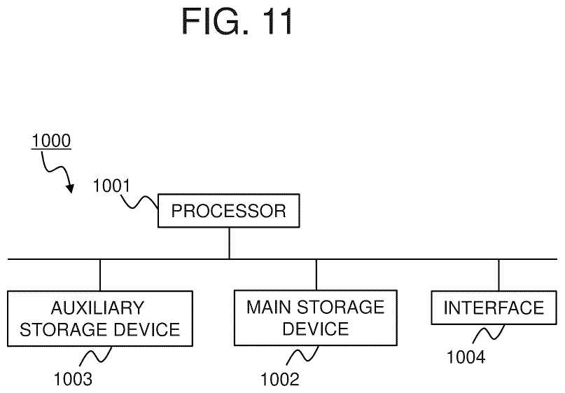

FIG. 11 is a schematic block diagram showing a configuration of a computer according to at least one example embodiment. The computer 1000 includes a processor 1001, a main storage device 1002, an auxiliary storage device 1003, and interface 1004. Additionally, as described above, the computer 1000 may be connected to a quantum computer or annealing machine.

The delivery plan creation system 190 described above is implemented on the computer 1000. The operations of the processing units described above are stored in the auxiliary storage device 1003 as a program (delivery plan creation program). The processor 1001 reads the program from the auxiliary storage device 1003, expands it into the main storage device 1002, and executes the above processes according to the program.

At least one example embodiment, the auxiliary storage device 1003 is an example of a non-temporary tangible medium. Other examples of non-temporary tangible media include magnetic disks, magneto-optical disks, CD-ROM (Compact Disc Read-only memory), DVD-ROM (Read-only memory), semiconductor memory, etc., connected via the interface 1004. When this program is delivered to the computer 1000 via a communication line, the computer 1000 may expand the program into the main storage device 1002 and execute the above processes according to the program.

The program may be for realizing part of the above-described functions. Furthermore, the program may be a differential file (differential program) realized in combination with other programs already stored in the auxiliary storage device 1003.

A part of or all of the above example embodiments may also be described as, but not limited to, the following supplementary notes.
(Supplementary note 1) A delivery plan creation system comprising:
   a delivery request accepting means for accepting input of an additional delivery request including a specification of multiple delivery conditions;
   a delivery request extracting means for extracting a delivery request corresponding to the input delivery conditions, including the additional delivery request;
   an optimizing means for optimizing a delivery plan for the extracted delivery request for each delivery condition; and
   an output means for outputting the optimized delivery plan for each delivery condition.
(Supplementary note 2) The delivery plan creation system according to Supplementary note 1, further comprising
   a delivery risk prediction means for predicting a delivery request expected to be made in the future corresponding to the input delivery conditions,
   wherein the delivery request extracting means extracts the predicted delivery request together.
(Supplementary note 3) The delivery plan creation system according to Supplementary note 1 or 2, further comprising
   a model generating unit for generating an objective function used for optimization by a Hamiltonian expression or an Ising model,
   wherein the optimizing means sends the generated objective function to a quantum computer or an annealing machine to execute optimization processing.
(Supplementary note 4) The delivery plan creation system according to any one of Supplementary notes 1 to 3,
   wherein the output means outputs comparative information comparing results optimized for each delivery condition.
(Supplementary note 5) The delivery plan creation system according to any one of Supplementary notes 1 to 4,
   wherein the optimizing means optimizes the delivery plan by minimizing an objective function defining the cost required for delivery.
(Supplementary note 6) The delivery plan creation system according to any one of Supplementary notes 1 to 5,
   wherein the optimizing means optimizes the delivery plan by minimizing an objective function defining the carbon dioxide emissions resulting from delivery.
(Supplementary note 7) The delivery plan creation system according to any one of Supplementary notes 1 to 6, wherein
   the delivery request accepting means accepts input of the additional delivery request including a specification of multiple delivery times as the delivery conditions,
   the delivery request extracting means extracts the delivery request scheduled for the specified delivery times, including the additional delivery request,
   the optimizing means optimizes the delivery plan for the extracted delivery request for each specified delivery time, and
   the output means outputs results optimized for each delivery time.
(Supplementary note 8) The delivery plan creation system according to any one of Supplementary notes 1 to 6, wherein
   the delivery request accepting means accepts input of the additional delivery request including a specification of multiple numbers of delivery vehicles as the delivery conditions,
   the optimizing means optimizes the delivery plan for the extracted delivery request for each specified number of delivery vehicles, and
   the output means outputs results optimized for each number of delivery vehicles.
(Supplementary note 9) The delivery plan creation system according to any one of Supplementary notes 1 to 6, wherein
   the delivery request accepting means accepts input of the additional delivery request including a specification of multiple delivery base attributes as the delivery conditions,
   the optimizing means optimizes the delivery plan for the extracted delivery request for each specified delivery base attribute, and
   the output means outputs the results optimized for each delivery base attribute.
(Supplementary note 10) A delivery plan creation method by a computer comprising:
   accepting input of an additional delivery request including a specification of multiple delivery conditions;
   extracting a delivery request corresponding to the input delivery conditions, including the additional delivery request;
   optimizing a delivery plan for the extracted delivery request for each delivery condition; and
   outputting the optimized delivery plan for each delivery condition.
(Supplementary note 11) A program storage medium storing a delivery plan creation program for causing a computer to execute:
   a delivery request accepting process for accepting input of an additional delivery request including a specification of multiple delivery conditions;
   a delivery request extracting process for extracting a delivery request corresponding to the input delivery conditions, including the additional delivery request;
   an optimizing process for optimizing a delivery plan for the extracted delivery request for each delivery condition; and
   an output process for outputting the optimized delivery plan for each delivery condition.
(Supplementary note 12) A delivery plan creation program for causing a computer to execute:
   a delivery request accepting process for accepting input of an additional delivery request including a specification of multiple delivery conditions;
   a delivery request extracting process for extracting a delivery request corresponding to the input delivery conditions, including the additional delivery request;
   an optimizing process for optimizing a delivery plan for the extracted delivery request for each delivery condition; and
   an output process for outputting the optimized delivery plan for each delivery condition.

The above description of the present invention is with reference to the example embodiments, but the present invention is not limited to the above example embodiments. Various changes can be made to the composition and details of the present invention that can be understood by those skilled in the art within the scope of the present invention.

### REFERENCE SIGNS LIST

10 Storage unit
20 Delivery request accepting unit
30 Delivery risk prediction unit
40 Delivery request extracting unit
50 Parameter calculating unit
60 Model generating unit
70 Optimizing processing unit
80 Output unit
100, 200 Delivery plan creation system
201 Quantum computer
202 Annealing machine

What is claimed is:

1. A delivery plan creation system comprising:
a memory storing instructions; and
one or more processors configured to execute the instructions to:
accept input of an additional delivery request including a specification of multiple delivery conditions;
extract a delivery request corresponding to the input delivery conditions, including the additional delivery request;
optimize a delivery plan for the extracted delivery request for each delivery condition; and
output the optimized delivery plan for each delivery condition.

2. The delivery plan creation system according to claim 1, wherein the processor is configured to execute the instructions to:
predict a delivery request expected to be made in the future corresponding to the input delivery conditions; and
extract the predicted delivery request together.

3. The delivery plan creation system according to claim 1, wherein the processor is configured to execute the instructions to:
generate an objective function used for optimization by a Hamiltonian expression or an Ising model; and
send the generated objective function to a quantum computer or an annealing machine to execute optimization processing.

4. The delivery plan creation system according to claim 1,
wherein the processor is configured to execute the instructions to output comparative information comparing results optimized for each delivery condition.

5. The delivery plan creation system according to claim 1,
wherein the processor is configured to execute the instructions to optimize the delivery plan by minimizing an objective function defining the cost required for delivery.

6. The delivery plan creation system according to claim 1,
wherein the processor is configured to execute the instructions to optimize the delivery plan by minimizing an objective function defining the carbon dioxide emissions resulting from delivery.

7. The delivery plan creation system according to claim 1, wherein the processor is configured to execute the instructions to:
accept input of the additional delivery request including a specification of multiple delivery times as the delivery conditions;
extract the delivery request scheduled for the specified delivery times, including the additional delivery request;
optimize the delivery plan for the extracted delivery request for each specified delivery time; and
output results optimized for each delivery time.

8. The delivery plan creation system according to claim 1, wherein the processor is configured to execute the instructions to:
accept input of the additional delivery request including a specification of multiple numbers of delivery vehicles as the delivery conditions;
optimize the delivery plan for the extracted delivery request for each specified number of delivery vehicles and
output results optimized for each number of delivery vehicles.

9. The delivery plan creation system according to claim 1, wherein the processor is configured to execute the instructions to:
accept input of the additional delivery request including a specification of multiple delivery base attributes as the delivery conditions;
optimize the delivery plan for the extracted delivery request for each specified delivery base attribute; and
output the results optimized for each delivery base attribute.

10. A delivery plan creation method by a computer comprising:
accepting input of an additional delivery request including a specification of multiple delivery conditions;
extracting a delivery request corresponding to the input delivery conditions, including the additional delivery request;
optimizing a delivery plan for the extracted delivery request for each delivery condition; and
outputting the optimized delivery plan for each delivery condition.

11. A non-transitory computer readable information recording medium storing a delivery plan creation program, when executed by a processor, that performs a method for:
accepting input of an additional delivery request including a specification of multiple delivery conditions;
extracting a delivery request corresponding to the input delivery conditions, including the additional delivery request;
optimizing a delivery plan for the extracted delivery request for each delivery condition; and
outputting the optimized delivery plan for each delivery condition.
